(19) United States
(12) Patent Application Publication
(10) Pub. No.: US 2007/0077934 A1
(43) Pub. Date: Apr. 5, 2007

(54) Dynamic reuse partitioning and subchannel allocation scheme in multicell OFDMA downlink systems

(76) Inventors: Aik Chindapol, Princeton, NJ (US); Jian Cao, New Haven, CT (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/541,284

(22) Filed: Sep. 28, 2006

Related U.S. Application Data
(60) Provisional application No. 60/722,201, filed on Sep. 30, 2005.
(60) Provisional application No. 60/786,333, filed on Mar. 27, 2006.

(51) Int. Cl. H04Q 7/20

(52) U.S. Cl. 455/447

(57) ABSTRACT

The reuse partitioning problem for a cellular orthogonal frequency division multiple access (OFDMA) system with dynamic subcarrier allocation is considered. One objective is to allocate the network resources in an efficient way in order to maximize the system's total throughput under individual user's quality-of-service (QoS) constraint. A suboptimal two-step approach is used where the radio network controller (RNC) solves the network planning problem and each base station (BS) solves the cell throughput maximization problem. Compared with the optimal resource allocation scheme, the approach described herein has much lower computational complexity in the RNC. Moreover, the communication overhead between each BS and the RNC is reduced substantially which renders our approach more practical for delay sensitive applications. Throughput increase is demonstrated

### STATEMENT OF RELATED CASES

This application claims the benefit of U.S. Provisional Application No. 60/722,201, filed Sep. 30, 2005 and of U.S. Provisional Application No. 60/786,333, filed on Mar. 27, 2006, both of which are incorporated herein by reference.

### BACKGROUND OF THE INVENTION

The present invention generally relates to wireless communications systems and methods.

The demand of mobile voice and data services is expected to grow rapidly. Increasing the system capacity while maintaining the minimum quality-of-service (QoS) requirement of every user is one of the main issues that needs to be investigated in these systems.

The conventional cellular concept represents a milestone for the efficient use of the radio resources. The service area is divided into a number of cells and the radio resources are allocated to each cell in such a way that some minimum transmission rate is achievable at any location in the entire cell. Frequency reuse is one of the well-known techniques to allocate resources to different cells.

One consequence of the above design is that mobile users, who are close to their serving base station (BS), experience a much higher signal quality compared with the mobiles users who are located near the edge of a cell. For users with high signal quality, they can tolerate a higher level of interference, which makes a denser reuse of channels possible. The concept of reuse partitioning, where a cell is divided into concentric zones, each with a different reuse pattern, has been proposed to increase the system total capacity. See, for example the following references: S. W. Halpern, “Reuse partitioning in cellular systems”, Proc. VTC, pp. 322-327, 1983; J. F. Whitehead, “Cellular spectrum efficiency via reuse planning”, Proc. VTC, pp. 16-20, 198; and J. Zander and M. Frodigh, “Capacity allocation and channel assignment in cellular radio systems using reuse partitioning”, Electronics Letters, Vol. 28, 1992, all of which are hereby incorporated by reference.

Recently, orthogonal frequency division multiple access (OFDMA) systems have been proposed to implement high data rate transmission in cellular networks. See, for example, J. Chuang and N. Sollenberger, “Beyond 3G: wideband wireless data access based on OFDM and dynamic packet assigment”, IEEE Communications Magazine, Vol. 38, pp. 78-87, 2000, which is hereby incorporated by reference. In OFDMA systems, various dynamic subcarrier allocation and scheduling schemes have been proposed by many researchers to increase the system throughput under some fairness or QoS constraints. In Y. W. Cheng and R. Cheng and K. B. Letaief and R. Murch, “Multiuser OFDM with adaptive subcarrier, bit and power allocation”, IEEE Journal on Selected Areas in Communications, Vol. 17, pp. 1747-1758, 1999, a near optimal power and bit allocation scheme is proposed to minimize the total transmit power while maintaining QoS for each user. A low complexity algorithm with adaptive modulation and adaptive multiple-access control and cell selection is proposed in Y. J. Zhang and K. B. Letaief, “Multiuser adaptive subcarrier-and-bit allocation with adaptive cell selection for OFDM systems”, IEEE Tran. on Wireless Communications, Vol: 3, pp. 1566-1575, 2004, where significant improvement in spectral efficiency is shown. In P. Svedman and S. Wilson and B. Ottersten, “A QoS-aware proportional fair scheduler for opportunistic OFDM”, Proc. VTC, pp. 558-562, 2004, a proportional fair scheduler is proposed to accommodate several QoS classes.

In a multicell OFDMA system, the concept of reuse partitioning is not investigated jointly with dynamic subcarrier allocation in most previous works. In a recent work, however, the joint problem of reuse partitioning and dynamic subcarrier allocation was considered. See, H. Kim and Y. Han and J. Koo, “Optimal subchannel allocation scheme in multicell OFDMA systems”, Proc. VTC, pp. 1821-1825, 2004. There, the authors formulate a linear programming problem that maximizes the total system throughput while guaranteeing QoS for each user. Through simulation, it is also demonstrated that the proposed scheme provides significant throughput improvement. One drawback of the above scheme, however, is that every mobile user has to calculate and report the best achievable rate of a subcarrier to the serving BS for all frequency reuse factors. Then each BS forwards all the information to the radio network controller (RNC), and the RNC solves the linear programming problem which gives the optimal subcarrier allocation. It can be seen that a substantial amount of communication overhead is involved between each mobile user and the serving Base Station (BS) as well as between each BS and the RNC. Moreover, the RNC needs to consume a lot of computational power in order to solve the linear programming problem in a timely manner. Finally, the concentric zone concept which was used intensively in reuse partitioning scheme is not explicitly addressed by H. Kim and Y. Han and J. Koo. Instead, a mobile station is allowed to use subcarriers with different frequency reuse factors.

### SUMMARY OF THE INVENTION

One aspect of the present invention considers the joint problem of reuse partitioning and dynamic subcarrier allocation in cellular OFDMA systems with the QoS constraint from individual user. In accordance with a further aspect of the present invention, the joint problem is divided into two subproblems and a two-step suboptimal approach is adopted. In the first subproblem, the RNC solves the network planning (i.e. reuse partitioning) problem based on its limited information about every user in all cells. In the second subproblem, given the reuse partitioning pattern determined by the RNC, each BS solves the throughput maximization problem in its cell based on the accurate information about every user in the cell. Compared with the optimal scheme, this approach requires less amount of communication overhead and less computational power which makes it more practical for delay sensitive applications.

In accordance with one aspect of the present invention, a method of controlling a cellular communication system having a plurality of users and a plurality of cells is provided. Each of the plurality of cells has a plurality of possible inner radii r. A first equation is solved for the throughput for the cellular communication system for each of the plurality of possible inner radii r The first equation is a function of the number of subcarriers, the frequency reuse and the size of the plurality of cells.

Once the first equation is solved, one of the plurality of possible inner radii r is selected so as to maximize the first equation for throughput.

Then a second equation is solved for throughput of each user, the second equation being a function or the one of the plurality of possible inner radii r.

In accordance with another aspect of the present invention, the second equation is solved at a base station in each of the plurality of cells and the first equation is solved at a radio network controller.

The method of the present invention is preferably used to set communication parameters of the cellular communication system based on the second equation. For example, each of a plurality of base stations can allocate subcarriers to a plurality of mobile communication units based on a throughput maximization solution.

In accordance with a further aspect of the present invention, the cellular communication system is an orthogonal frequency division multiple access system. It can also be used on other types of systems, for example, systems with no intra cell interference and granular bin allocations

In accordance with another aspect of the present invention, the first equation is

$${T}^{*} = {max}_{{N}_{1} , {N}_{p}} {\sum }_{b = 1}^{B} {t}_{r , j}^{*} {N}_{p} + {t}_{r , i}^{*} {N}_{1}$$

subject to:
N₁+pNₚ=M (5)
t_{r,j}^{*}Nₚ≧T₁_{_{j,t}}^{b}∀b (6)
t_{t,i}^{*}≧T₁_{_{i,t}}^{b}∀b, (6)

In accordance with a further aspect of the present invention, the second equation is:

$$\begin{matrix}{max}_{{n}_{i}^{b} , {n}_{j}^{b}} {\sum }_{i ∈ {𝕀}_{i}} {t}_{i}^{b} {n}_{i}^{b} + {\sum }_{j ∈ {𝕀}_{j}} {t}_{j}^{b} {n}_{j}^{b} \\ subject to & ( 8 ) \\ {t}_{i}^{b} {n}_{i}^{b} \geq {t}^{min} , ∀ i & ( 9 ) \\ {t}_{j}^{b} {n}_{j}^{b} \geq {t}^{min} , ∀ j & ( 10 ) \\ {\sum }_{i} {n}_{i}^{b} = {N}_{1} & ( 11 ) \\ {\sum }_{j} {n}_{j}^{b} = {N}_{ρ} & ( 12 )\end{matrix}$$

where nᵢ^{b} is the number of sub-channels allocated to a user i who is in the inner hexagon and nⱼ^{b} is the number of sub-channels allocated to a user j who is in the outer ring, tᵢ^{b} is an actual rate the user i can get and tⱼ^{b} is an actual rate the user j can get.

The present invention also contemplates a system for controlling a cellular communication system. The system includes a radio network controller in communication with each of a plurality of base stations. The radio network controller (1) solves a first equation for throughput for the cellular communication system for each of the plurality of possible inner radii r, the first equation being a function of the number of subcarriers, the frequency reuse and the size of the plurality of cells and (2) selects one of the plurality of possible inner radii r that maximizes the first equation for throughput. The system also includes the plurality of base stations. Each of the plurality of base stations is associated with a cell that has a plurality of users and each of the plurality of base stations solves a second equation for throughput of each of the plurality of users, the second equation being a function or the one of the plurality of possible inner radii r

The first and second equations can be solved by any appropriate processor in the cellular communication system.

### DESCRIPTION OF THE DRAWINGS

FIG. 1 illustrates a cell phone system.

FIG. 2 illustrates a two layer cell structure.

FIG. 3 illustrates a uniform layout after the RNC completes a large scaled network planning step.

FIG. 4 illustrates an overlayed network structure.

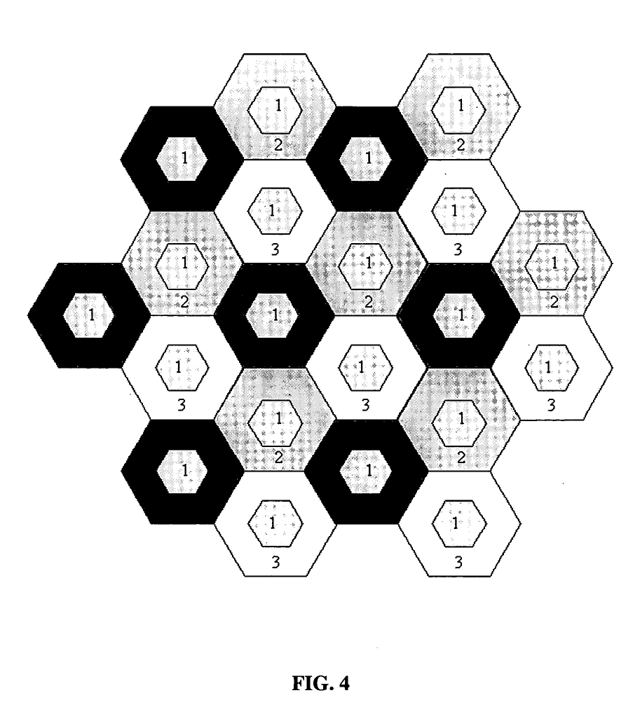

FIG. 5 illustrates a network structure with frequency reuse factor 3.

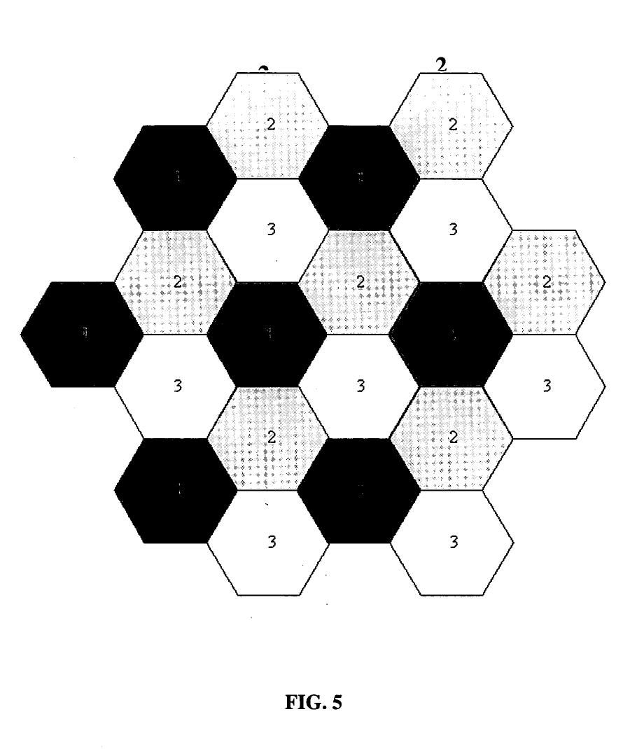

FIG. 6 illustrates a frame structure of IEEE 802.16 in TDD mode.

### DESCRIPTION OF A PREFERRED EMBODIMENT

In this specification, the system model and the problem formulation is introduced first. Then the two-step approach in accordance with one aspect of the present invention is presented. Then, simulation results are presented.

System Model and Problem Formulation

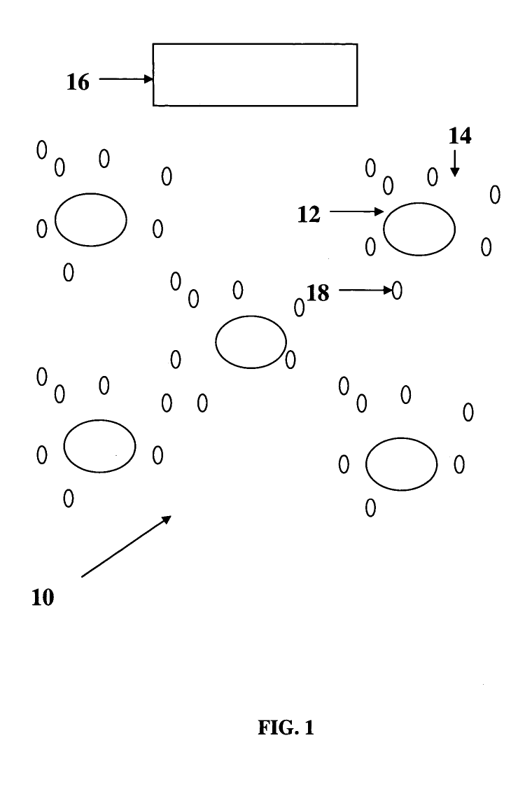

A downlink multicell OFDMA system 10 is illustrated in FIG. 1. There is one base station (“BS”) 12 located at the center of each cell 14 and there is a central Radio Network Controller (“RNC”) 16 which controls each BS 12. An OFDMA subcarrier is regarded as one transmission unit and it is assumed that one subcarrier can not be simultaneously used by more than one mobile user 18. Therefore, there is no intracell interference and the only factor impacting the transmission rate is interference from neighboring cells. Moreover, all the subcarriers are assumed to have the same power. Within each cell of radius R, there are at most 2 M subcarriers to be allocated to the active users in the cell. It is noted that if the frequency reuse factor is not equal to 1, then there are less than M subcarriers available in each cell.

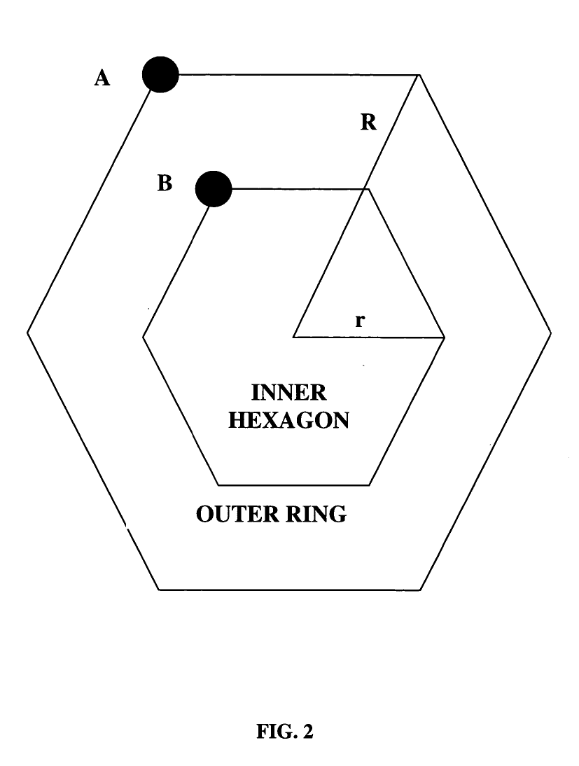

Each BS 12 is able to implement a two-layer structure with two concentric hexagons as shown in FIG. 2. The inner concentric hexagon is labeled INNER HEXAGON and the outer concentric hexagon is labeled OUTER RING. The frequency reuse factor is set to 1 for the inner hexagon of radius r and frequency reuse factor is set to p for the outer ring, where p≧1. It is further assumed that the data rate per subcarrier of a mobile user with the signal-to-interference ratio of SIR is given by min (W log (1+SIR), Rₗᵢₘᵢₜ), where W is the bandwidth of one subcarrier. Under the equal power assumption where all BS's use the same transmit power, the SIR can be calculated as:

$$\frac{{d}_{i , 0}^{- k}}{{\sum }_{i} {d}_{i , 1}^{- k}}$$

where d_{i,0} is the distance between the i^{th} user and the serving BS, d_{i,1} is the distance between the i^{th} user and the l^{th} interfering BS and k is the attenuation factor. No power control and no fading/shadowing effects are assumed.

FIG. 2 illustrates a two-layer structure in a cell where R is the radius of the cell and r is the radius of the inner hexagon. A is the worst case location for a user located in the outer ring and B is the worst case location for a user located in the inner hexagon.

The objective is to find the optimal radius of the inner hexagon for every cell and the optimal subcarrier allocation for users located in both the inner hexagon and the outer ring in each cell so that the total system throughput T is maximized. The optimization problem can be explicitly written as:

$$\begin{matrix}T = {max}_{r , {n}_{i}^{b} , {n}_{j}^{b}} {\sum }_{b = 1}^{B} ( {\sum }_{i ∈ {𝕀}_{i}} {t}_{i}^{b} {n}_{i}^{b} + {\sum }_{j ∈ {𝕀}_{j}} {t}_{j}^{b} {n}_{j}^{b} ) \\ subject to & ( 1 ) \\ {\sum }_{i ∈ {𝕀}_{i}} {n}_{i}^{b} + ρ {\sum }_{j ∈ {𝕀}_{j}} {t}_{j}^{b} {n}_{j}^{b} = M , ∀ b & ( 2 ) \\ {t}_{i}^{b} {n}_{i}^{b} \geq {t}_{i}^{b , min} = {t}^{min} , ∀ i , b & ( 3 )\end{matrix}$$

where:
Πᵢ is the set of users i in the inner hexagon;
Πⱼ is the set of users j in the outer ring;
tᵢ^{b} the data rate per subcarrier of user i in cell b;
B is the total number of cells in the system;
tᵢ^{b,min} is the minimum required rate of user i;
nᵢ^{b} is the number of subcarriers allocated to user i; and
nⱼ^{b} is the number of subcarriers allocated to user j.

For simplicity, it is assumed that all users have the same minimum rate requirement denoted by t^{min} and all users i in the inner hexagon have frequency reuse factor of 1 while the j^{th} user located in the outer ring uses the frequency reuse factor of p. Note that equation (2) is the constraint on the total number of subcarriers in each cell and equation (3) guarantees the minimum rate (QoS) requirement constraint for all users. Since the frequency reuse factor p≧1, there are less than M subcarriers available in each cell.

The Two-step Approach

In order to solve the system throughput maximization problem optimally, the central RNC 16 needs to know the exact location of all users 18 in all cells 14. Since all mobile users 18 are free to move, the only way that the RNC 16 is able to know the location of all users 18 is to let users in a cell 14 report their exact locations to the serving BS 12 and then the BSs 12 forward all the information to the RNC 16. In certain conditions, the receive signal strength or SIR may be used in place of the exact location. Nevertheless, this feedback mechanism requires a huge amount of communication overhead between all mobile users 18 and their serving BS 12 as well as between all BSs 12 and the RNC 16. Even if the system can accommodate this amount of communication overhead, the RNC 16 still needs to solve, for every possible value of r, an integer programming problem with a large number of variables. Therefore, a large delay and a substantial amount of computational power are expected at the RNC 16 while solving this optimization problem.

All of the above drawbacks render the optimal scheme unpractical for real system implementation, especially for delay sensitive mobile networks. Therefore, one aspect of the present invention decomposes the joint problem of reuse partitioning and dynamic subcarrier allocation into two subproblems. This suggests a two-step approach to solve the joint problem in a suboptimal way. The first subproblem is the “large scaled network planning” problem, where the RNC 16 needs to determine the radius r of the inner hexagon for every cell and the number of subcarriers allocated to both the inner hexagon and the outer ring in each cell based on limited information about all users 18 in each cell 14, while guaranteeing the minimum rate requirement of all users 18.

The second subproblem is the “small scaled cell throughput maximization” problem, where each BS 12, subject to the network planning results determined by the RNC 16, allocates the subcarriers to users in both the inner hexagon and the outer ring to maximize its cell's throughput based on its full knowledge of users' 18 locations within the cell 14.

One example of the 2-step approach is described below:

1. It is assumed that t^{min} is known by all the BSs 12, and there is a pre-defined radius set X where the radius of the inner hexagon r can only take values from this set.

2. During the association period, each mobile user 18 in a cell 14 reports its exact location to the serving BS 12.

3. Each BS b reports

$$( {T}_{\prod j , r}^{b} , {T}_{\prod i , r}^{b} )$$

to the RNC 16 for all r∈X. This means that for every pre-defined radius in the set X, each BS 12 reports two numbers to the RNC 16, where

$${T}_{{\prod }_{j , r}}^{b} = {\sum }_{j ∈ {\prod }_{j}} {t}^{min}$$

is the total rate requirement of active users in the outer ring and

$${T}_{{\prod }_{i , r}}^{b} = {\sum }_{i ∈ {\prod }_{i}} {t}^{min}$$

is the total rate requirement of active users in the inner hexagon when the radius of inner hexagon is r. For example, if there are L elements in the set X, each BS 12 reports an L×2 matrix.

4. Large scaled network planning: the RNC 16 solves the following optimization problem for each r∈X:

$${T}^{*} = {max}_{{N}_{1} , {N}_{p}} {\sum }_{b = 1}^{B} {t}_{r , j}^{*} {N}_{p} + {t}_{r , i}^{*} {N}_{1}$$

subject to:
N₁+pNₚ=M (5)
t_{r,j}^{*}Nₚ≧T₁_{_{j,r}}^{b}∀b (6)
t_{r,i}^{*}N₁≧T₁_{_{i,r}}^{b}∀b, (7)
where t_{r,j}^{*} is the worst case rate per sub-channel for the outer ring with frequency reuse factor p and t_{r,j}^{*} is the worst case rate per sub-channel for the inner hexagon with reuse factor of 1. These worst case rates can be calculated by assuming users are located at the worst case locations shown in FIG. 2. Nᵢ and Nₚ are the total number of subcarriers allocated in the inner and outer regions respectively.

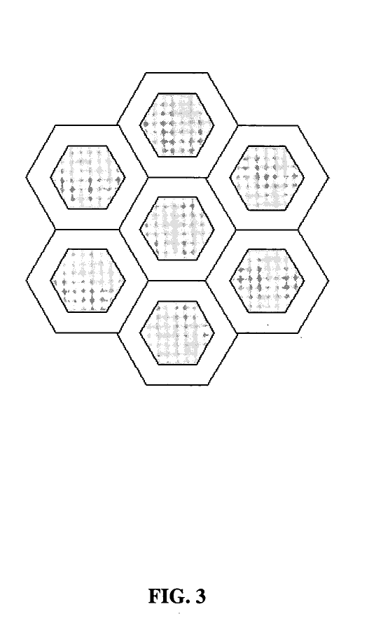

5. After solving the above optimization problem for each r∈X, the RNC 16 picks the radius r* which has the highest system throughput and reports (r*, N₁, Nₚ) to each BS 12. Thus, all cells will end up with a uniform layout. Each cell will have the same radius for the inner hexagon and same N₁ and Nₚ as shown in FIG. 3. Note that if no feasible solution exists for every r∈X , then the RNC 16 reports (0, 0, M/p) to each BS 12 which means that a standard network setting with frequency reuse factor p will be adopted.

6. Small scaled cell throughput maximization is performed. After obtaining (r*, N₁, Nₚ) from the RNC 16, each BS b solves:

$$\begin{matrix}{max}_{{n}_{i}^{b} , {n}_{j}^{b}} {\sum }_{i ∈ {𝕀}_{i}} {t}_{i}^{b} {n}_{i}^{b} + {\sum }_{j ∈ {𝕀}_{j}} {t}_{j}^{b} {n}_{j}^{b} \\ subject to & ( 8 ) \\ {t}_{i}^{b} {n}_{i}^{b} \geq {t}^{min} , ∀ i & ( 9 ) \\ {t}_{j}^{b} {n}_{j}^{b} \geq {t}^{min} , ∀ j & ( 10 ) \\ {\sum }_{i} {n}_{i}^{b} = {N}_{1} & ( 11 ) \\ {\sum }_{j} {n}_{j}^{b} = {N}_{ρ} & ( 12 )\end{matrix}$$

where nᵢ^{b} is the number of sub-channels allocated to user i who is in the inner hexagon and nⱼ^{b} is the number of sub-channels allocated to user j who is in the outer ring. tᵢ^{b} is the actual rate user i can get (a BS 12 can calculate this value because user i's exact location is known to the BS 12 and the network planning result is given by the RNC 16), and tⱼ^{b} is the actual rate user j can get.

Note that in step 3), each BS 12 only reports partial information to the RNC 16 which reduces the communication overhead between each BS 12 and the RNC 16. In step 4), the RNC 16 solves the large scaled network planning problem based on its limited information about all users. Since the RNC 16 needs to guarantee the minimum rate requirement for all users, it has to deal with the worst case situations which are illustrated in equations (6) and (7). However, the computational complexity of the optimization problem in Equation (4) is actually very low. N₁ can be replaced by M—pNₚ, and the optimization problem reduces to

$$\begin{matrix}{max}_{{N}_{ρ}} {\sum }_{b = 1}^{B} {t}_{r , j}^{*} {N}_{ρ} + {t}_{r , i}^{*} ( M - ρ {N}_{ρ} ) \\ subject to & ( 13 ) \\ {t}_{r , j}^{*} {N}_{ρ} \geq {T}_{{𝕀}_{j , r}}^{b} ∀ b & ( 14 ) \\ {t}_{r , i}^{*} {N}_{1} \geq {T}_{{𝕀}_{1 , r}}^{b} ∀ b & ( 15 )\end{matrix}$$

It is clear that the above single variable optimization problem is easy to solve. In step 6), each BS 12 does need to solve a linear programming problem, as shown in Equation (8), to maximize the throughput in each individual cell 12. But, compared with the optimization problem in Equation (1), the computational complexity is reduced dramatically, because the radius of the inner hexagon is already determined by the RNC 16 and the number of variables is also reduced substantially.

FIG. 3 illustrates the uniform layout after the RNC 16 completes the large scaled network planning step.

The joint problem of reuse partitioning and dynamic subcarrier allocation in an OFDMA downlink system has been considered. In order to reduce both the communication overhead and computational complexity, the joint problem is separated into two subproblems. The RNC solves the large scaled network planning problem based on its limited information about all users while guaranteeing all users' minimum rate requirement. Given the network planning results, each BS solves the small scaled cell throughput maximization problem based on its full knowledge of users' locations within its cell. Our simulation results demonstrate the fact that, even though our proposed scheme has less communication overhead and requires less computational power. Thus, the total throughput can be increased dramatically over the standard configuration.

The approach set forth above can be extended in accordance with further aspects of the present invention. In the extension, the optimization problem can, once again, be explicitly written as:

$$T = {max}_{r , {n}_{i}^{b} , {n}_{j}^{b}} {\sum }_{b = 1}^{B} ( {\sum }_{i ∈ {𝕀}_{i}} {t}_{i}^{b} {n}_{i}^{b} + {\sum }_{j ∈ {𝕀}_{j}} {t}_{j}^{b} {n}_{j}^{b} )$$

$$subject to$$

$${\sum }_{i ∈ {𝕀}_{i}} {n}_{i}^{b} + ρ {\sum }_{j ∈ {𝕀}_{j}} {n}_{j}^{b} = M , ∀ b$$

$${t}_{i}^{b} {n}_{i}^{b} \geq {t}_{i}^{b , min} = {t}^{min} , ∀ i , b$$

$${t}_{j}^{b} {n}_{j}^{b} \geq {t}_{j}^{b , min} = {t}^{min} , ∀ j , b$$

where:
Πᵢ is the set of users i in the inner hexagon;
Πⱼ is the set of users j in the outer ring;
tᵢ^{b} is the data rate per subcarrier of user i in cell b;
B is the total number of cells in the system;
tᵢ^{b,min} is the minimum required rate of user i;
nⱼ^{b} is the number of subcarriers allocated to user i; and
nⱼ^{b} is the number of subcarriers allocated to user j.

As before, for simplicity, it has been assumed that all users have the same minimum rate requirement denoted by t^{min} and all users i in the inner hexagon have frequency reuse factor of 1 while the user located in the outer ring uses the frequency reuse factor of p. The second equation in the above paragraph is the constraint on the total number of subcarriers in each cell, and the third and furth equations in the above paragraph guarantee the minimum rate (QoS) requirement constraint for all users. Since the frequency reuse factor p>1, there are less than M subcarriers available in each cell.

Once again, a two-step process is used.

First, the large scaled network planning problem is solved. To optimize the whole network throughput, the RNC 16 solves the following problem and reports the optimal radius r*, the number of subcarriers allocated in the inner region N₁ and the outer region Nₚ to each BS 12.

$$\begin{matrix}{max }_{r ∈ X} {max}_{{N}_{ρ}} {\sum }_{b = 1}^{B} {t}_{r , j}^{*} {N}_{ρ} + {t}_{r , i}^{*} ( M - ρ {N}_{ρ} ) \\ subject to \\ {t}_{r , j}^{*} {N}_{ρ} \geq {T}_{{𝕀}_{j , r}}^{b} ∀ b \\ {t}_{r , i}^{*} {N}_{1} \geq {T}_{{𝕀}_{1 , r}}^{b} ∀ b ,\end{matrix}$$

where X is the pre-defined set of the inner radius, t_{r,j}^{*} is the worst case rate per sub-channel for the outer ring with frequency reuse factor p and t_{r,i}^{*} is the worst case rate per sub-channel for the inner hexagon with reuse factor of 1 and

$${T}_{\prod j , r}^{b} and {T}_{\prod i , r}^{b}$$

are the total rate requirement reported by the base station b of active users in the outer region and the inner region of size r, respectively, as those regions are illustrated in FIG. 2. These worst case rates can be calculated by assuming users are located at the worst case locations shown in FIG. 2. N₁ and Nₚ are the total number of subcarriers allocated in the inner and outer regions respectively.

Next, small scaled cell throughput maximization is performed. After obtaining (r*, N₁, Nₚ) from the RNC 16, each BS b solves

$$\begin{matrix}{max}_{{n}_{i}^{b} , {n}_{j}^{b}} {\sum }_{i ∈ {𝕀}_{i}} {t}_{i}^{b} {n}_{i}^{b} + {\sum }_{j ∈ {𝕀}_{j}} {t}_{j}^{b} {n}_{j}^{b} \\ subject to \\ {t}_{i}^{b} {n}_{i}^{b} \geq {t}^{min} , ∀ i \\ {t}_{j}^{b} {n}_{j}^{b} \geq {t}^{min} , ∀ j \\ {\sum }_{i} {n}_{i}^{b} = {N}_{1} \\ {\sum }_{j} {n}_{j}^{b} = {N}_{ρ}\end{matrix} \qquad ( 6 )$$

where nᵢ^{b} is the number of sub-channels allocated to user i who is in the inner hexagon and nⱼ^{b} is the number of sub-channels allocated to user j who is in the outer ring. tᵢ^{b} is the actual rate user i can get (a BS 12 can calculate this value because user i's exact location is known to the BS 12 and the network planning result is given by the RNC 16), and tⱼ^{b} is the actual rate user j can get.

Extended optimization steps suitable for practical scenarios are now discussed.

A. Optimization of Frequency Reuse for Outer Regions

It can be seen that a goal is to maximize the total system throughput with respect to the inner radius r and the number of subcarriers assigned to users in the inner hexagon and the outer ring, nᵢ^{b} and nⱼ^{b}, respectively. However, the objective function can be further extended to include the frequency reuse of the outer region p. Therefore, the equation from paragraph 0036 can be rewritten as

$$\begin{matrix}T = {max}_{ρ , r , {n}_{i}^{b} , {n}_{j}^{b}} {\sum }_{b = 1}^{B} ( {\sum }_{i ∈ {𝕀}_{i}} {t}_{i}^{b} {n}_{i}^{b} + {\sum }_{j ∈ {𝕀}_{j}} {t}_{j}^{b} {n}_{j}^{b} ) \\ subject to \\ {\sum }_{i ∈ {𝕀}_{i}} {n}_{i}^{b} + ρ {\sum }_{j ∈ {𝕀}_{j}} {n}_{j}^{b} = M , ∀ b \\ {t}_{i}^{b} {n}_{i}^{b} \geq {t}_{i}^{b , min} = {t}^{min} , ∀ i , b , \\ {t}_{j}^{b} {n}_{j}^{b} \geq {t}_{j}^{b , min} = {t}^{min} , ∀ j , b .\end{matrix} \qquad ( 7 )$$

Similarly the large scaled network planning can be rewritten as

$$\begin{matrix}\begin{matrix}{T}^{*} = {max }_{ρ} { max }_{r ∈ X} {max}_{{N}_{1} , {N}_{ρ}} {\sum }_{b = 1}^{B} {t}_{r , j}^{*} {N}_{ρ} + {t}_{r , i}^{*} {N}_{1} , \\ subject to \\ {N}_{1} + ρ {N}_{ρ} = M \\ {t}_{r , j}^{*} {N}_{ρ} \geq {T}_{{𝕀}_{j , r}}^{b} ∀ b \\ {t}_{r , i}^{*} {N}_{1} \geq {T}_{{𝕀}_{1 , r}}^{b} ∀ b , \\ or\end{matrix} & ( 8 ) \\ \begin{matrix}{T}^{*} = {max }_{ρ} { max }_{r ∈ X} {max}_{{N}_{ρ}} {\sum }_{b = 1}^{B} {t}_{r , j}^{*} {N}_{ρ} + {t}_{r , i}^{*} ( M - ρ {N}_{ρ} ) \\ subject to \\ {t}_{r , j}^{*} {N}_{ρ} \geq {T}_{{𝕀}_{j , r}}^{b} ∀ b \\ {t}_{r , i}^{*} {N}_{1} \geq {T}_{{𝕀}_{i , r}}^{b} ∀ b .\end{matrix} & ( 9 )\end{matrix}$$

After solving the above optimization problem, the RNC 16 forwards the values (p, r, N₁, Nₚ) that satisfy equations (8) or (9) above to each BS 12. Note that the transmit power of the inner hexagon can be easily inferred from the radius r. In certain conditions such as those with high-level of intercell interference or largely nonuniform user distribution, it is possible that no feasible solution with r>0 exists and the optimization over the radius r may be dropped and equation (8) is reduced to:

$${T}^{*} = {max}_{ρ} {\sum }_{b = 1}^{B} {t}_{r , j}^{*} \frac{M}{ρ} \\ subject to \\ {t}_{r , j}^{*} \frac{M}{ρ} \geq {T}_{{𝕀}_{j , r}}^{b} ∀ b . \qquad ( 10 )$$

In this case, the RNC reports (p, 0, 0, M/p) to each BS 12, indicating the standard network configuration is being used.

It can be seen that with concentric reuse partitioning and dynamic resource allocation, the optimization and simultaneous allocation of power, frequency, bandwidth and sub-carriers can be achieved.

B. Optimization of Frequency Reuse for Inner and Outer Regions

Here, the optimization steps are further generalized by relax the requirement that the inner hexagon uses the frequency reuse of 1. Even though the frequency reuse of 1 simplifies the network deployment tremedously, the optimization method in accordance with one aspect of the present invention can be extended to the cases where the reuse factor of 1 is no longer optimal or feasible.

Let α be the frequency reuse factor of the inner hexagon and equation (7) from paragraph 0043 can be modified as

$$T = {max}_{α , ρ , r , {n}_{i}^{b} , {n}_{j}^{b}} {\sum }_{b = 1}^{B} ( {\sum }_{i ∈ {𝕀}_{i}} {t}_{i}^{b} {n}_{i}^{b} + {\sum }_{j ∈ {𝕀}_{j}} {t}_{j}^{b} {n}_{j}^{b} ) \\ subject to \\ α {\sum }_{i ∈ {𝕀}_{i}} {n}_{i}^{b} + ρ {\sum }_{j ∈ {𝕀}_{j}} {n}_{j}^{b} = M , ∀ b \\ {t}_{i}^{b} {n}_{i}^{b} \geq {t}_{i}^{b , min} = {t}^{min} , ∀ i , b , \\ {t}_{j}^{b} {n}_{j}^{b} \geq {t}_{j}^{b , min} = {t}^{min} , ∀ j , b . \qquad ( 11 )$$

Similarly the large scaled network planning shown in (8) can be modified as

$$\begin{matrix}{T}^{*} = {max }_{α , ρ} { max }_{r ∈ X} {max}_{{N}_{α} , {N}_{ρ}} {\sum }_{b = 1}^{B} {t}_{r , j}^{*} {N}_{ρ} + {t}_{r , i}^{*} {N}_{α} , \\ subject to \\ α {N}_{α} + ρ {N}_{ρ} = M \\ {t}_{r , j}^{*} {N}_{ρ} \geq {T}_{{𝕀}_{j , r}}^{b} ∀ b \\ {t}_{r , i}^{*} {N}_{α} \geq {T}_{{𝕀}_{1 , r}}^{b} ∀ b .\end{matrix} \qquad ( 12 )$$

For the optimization of α and p. the choices of reuse factor can be limited to a few practical values, such as 1, 3 and 7 so that it does not cause an extensive computational burden. Then the RNC 16 has to report (α, p, r, N_{α}, Nₚ) to each BS 12 for small scaled throughput maximization as shown in equation (6) in paragraph 0040.

C. Non-Uniform Rate Requirements

For simplicity, it has been assumed that all users have the same minimum rate requirement, t^{min}. However, the optimization steps shown in the previous equations can be used with non-uniform user rate requirements. Specifically, the total rate requirement reported by BS b for active users in the inner hexagon and the outer region used in paragraphs 0036, 0044, 0050 and 0051 can be shown

$${T}_{{\prod }_{i , r}}^{b} = {\sum }_{i ∈ {\prod }_{i}} {t}_{i}^{b , min} and {T}_{{\prod }_{, r}}^{b} = {\sum }_{j ∈ {\prod }_{i}} {t}_{i}^{b , min} ,$$

respectively. Note that this change does not impact the large scaled network planning as the RNC 16 only needs to know the sum rate requirements of all users in each cell. However, each BS b needs to solve the following small scaled optimization:

$${max}_{{n}_{i}^{b} , {n}_{j}^{b}} {\sum }_{i ∈ {I}_{i}} {t}_{i}^{b} {n}_{i}^{b} + {\sum }_{j ∈ {I}_{i}} {t}_{j}^{b} {n}_{j}^{b} \\ \begin{matrix}subject to {t}_{i}^{b} {n}_{i}^{b} \geq {t}_{i}^{b , min} , ∀ i \\ {t}_{j}^{b} {n}_{j}^{b} \geq {t}_{j}^{b , min} , ∀ j \\ {\sum }_{i} {n}_{i}^{b} = {N}_{1} \\ {\sum }_{j} {n}_{j}^{b} = {N}_{ρ}\end{matrix} \qquad ( 13 )$$

which simply is the generalization of equation (6) from paragraph 0040.

D. Application to IEEE 802.16 and Similar OFDMA Systems

The present invention can be applied to the IEEE 802.16 frame structure, as an example. It is described how the concentric cell allocation be used with IEEE 802.16.

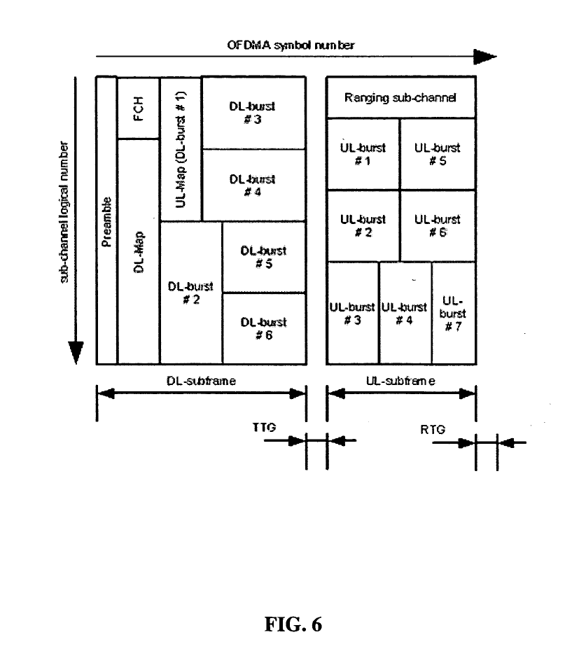

FIG. 6 shows the 802.16 frame structure and sub-carrier allocation to the downlink and uplink traffic. It can be seen that different burst units can be allocated to the inner and outer regions of the concentric reuse partitioning cell. The handover between the inner hexagon and the outer region in this case requires minimal signalling because the BS 12 can simply allocate users who need to switch between the inner and outer regions different burst allocation.

Accordingly, the present invention allows the ability to adjust the frequency reuse factors for both inner and outer cells, the radius of the inner cell (and its corresponding power), and the assigned throughput of each user (in both the inner and outer cells). Here, a suboptimal approach is provided that allows the features to be simultaneously adjusted.

The following references provide background information generally related to the present invention and are hereby incorporated by reference: [1] S. W. Halpern, “Reuse partitioning in cellular systems”, Proc. VTC, pp. 322-327, 1983; [2] J. F. Whitehead, “Cellular spectrum efficiency via reuse planning”, Proc. VTC, pp. 16-20, 1985;. [3] J. Zander and M. Frodigh, “Capacity allocation and channel assignment in cellular radio systems using reuse partitioning”, Electronics Letters, Vol. 28, 1992; [4] J. Chuang and N. Sollenberger, “Beyond 3G: wideband wireless data access based on OFDM and dynamic packet assigment”, IEEE Communications Magazine, Vol. 38, pp. 78-87, 2000; [5] Y. W. Cheng and R. Cheng and K. B. Letaief and R. Murch, “Multiuser OFDM with adaptive subcarrier, bit and power allocation”, IEEE Journal on Selected Areas in Communications, Vol. 17, pp. 1747-1758, 1999; [6] Y. J. Zhang and K. B. Letaief, “Multiuser adaptive subcarrier-and-bit allocation with adaptive cell selection for OFDM systems”, IEEE Tran. on Wireless Communications, Vol: 3, pp. 1566-1575, 2004; [7] P. Svedman and S. Wilson and B. Ottersten, “A QoS-aware proportional fair scheduler for opportunistic OFDM”, Proc. VTC, pp. 558-562, 2004; [8] H. Kim and Y. Han and J. Koo, “Optimal subchannel allocation scheme in multicell OFDMA systems”, Proc. VTC, pp. 1821-1825, 2004; [9] S. Lu, V. Bhsrghavan and R. Srikant, “Fair scheduling in wireless packet networks”, IEEE/ACM Trans. on Networking, Vol.7, pp. 473-489, Aug. 1999; [10] F. Berggren and it Jantti, “Asymptotically Fair Transmission Scheduling Over Fading Channels”, IEEE Trans. on Wireless Communications, Vol. 3, pp. 326-335, Jan. 2004; [11] IEEE 802.16-2004: Air Interface for Fixed Broadband Wireless Access systems, 2004; [12] 3GPP Physical Layer Aspects for Evolved UTRA, Technical Report TR 25.814v0.2.1, August 2005; and [13] G. Li and H. Liu, “Downlink dynamic resource allocation for multi-cell OFDMA system:’ Proc. VTC, pp. 1698-1702, 2003.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method of controlling a cellular communication system having a plurality of users and a plurality of cells, each of the plurality of cells having an inner portion with a plurality of possible inner radii r, an outer portion a plurality of possible frequency reuse factors, comprising:
solving a first equation for throughput for the cellular communication system for each of the plurality of possible inner radii r and frequency reuse factors for both inner and outer portions, the first equation being a function of the number of subcarriers, the frequency reuse and the size of the plurality of cells; and
selecting one of the plurality of possible inner radii r and frequency reuse factors that maximizes the first equation for throughput;
solving a second equation for throughput of each user, the second equation being a function of the one of the plurality of possible inner radii r and frequency reuse factors.

2. The method of claim 1, wherein the second equation is solved at a base station in each of the plurality of cells.

3. The method of claim 1, wherein the first equation is solved at a radio network controller.

4. The method of claim 2, wherein the first equation is solved at a radio network controller.

5. The method of claim 1, comprising setting communication parameters of the cellular communication system based on the second equation.

6. The method of claim 5, comprising setting a frequency reuse factor in an inner radius and an outer radius of a plurality of cells in the cellular communication system.

7. The method of claim 5, comprising setting a throughput for a plurality of cells in the cellular communication system.

8. The method of claim 1, comprising each of the plurality of base stations allocating subcarriers to a plurality of mobile communication units based on the throughput maximization solution.

9. The method of claim 1, wherein the cellular communication system is an orthogonal frequency division multiple access system.

10. The method of claim 1, wherein the first equation is
$${T}^{*} = {max}_{{N}_{1} , {N}_{p}} {\sum }_{b = 1}^{B} {t}_{r , j}^{*} {N}_{p} + {t}_{r , i}^{*} {N}_{1}$$
subject to:
N₁+pNₚ=M (5)
t_{r,j}^{*}Nₚ≧T_{j,r}^{b}∀b (6)
t_{r,i}^{*}N₁≧T_{i,r}^{b}∀b, (7)

11. The method of claim 1, wherein the second equation is:
$$\begin{matrix}{max}_{{n}_{i}^{b} , {n}_{j}^{b}} {\sum }_{i ∈ {I}_{i}} {t}_{i}^{b} {n}_{i}^{b} + {\sum }_{j ∈ {I}_{i}} {t}_{j}^{b} {n}_{j}^{b} & ( 8 ) \\ subject to {t}_{i}^{b} {n}_{i}^{b} \geq {t}^{min} , ∀ i & ( 9 ) \\ {t}_{j}^{b} {n}_{j}^{b} \geq {t}^{min} , ∀ j & ( 10 ) \\ {\sum }_{i} {n}_{i}^{b} = {N}_{1} & ( 11 ) \\ {\sum }_{j} {n}_{j}^{b} = {N}_{ρ} & ( 12 )\end{matrix}$$
where nᵢ^{b} is the number of sub-channels allocated to a user i who is in the inner hexagon and nⱼ^{b} is the number of sub-channels allocated to a user j who is in the outer ring, tᵢ^{b} is an actual rate the user i can get and tⱼ^{b}is an actual rate the user j can get.

12. The method of claim 10, wherein the second equation is:
$$\begin{matrix}{max}_{{n}_{i}^{b} , {n}_{j}^{b}} {\sum }_{i ∈ {I}_{i}} {t}_{i}^{b} {n}_{i}^{b} + {\sum }_{j ∈ {I}_{i}} {t}_{j}^{b} {n}_{j}^{b} & ( 8 ) \\ subject to {t}_{i}^{b} {n}_{i}^{b} \geq {t}^{min} , ∀ i & ( 9 ) \\ {t}_{j}^{b} {n}_{j}^{b} \geq {t}^{ min} , ∀ j & ( 10 ) \\ {\sum }_{i} {n}_{i}^{b} = {N}_{1} & ( 11 ) \\ {\sum }_{j} {n}_{j}^{b} = {N}_{ρ} & ( 12 )\end{matrix}$$
where nᵢ^{b} is the number of sub-channels allocated to a user i who is in the inner hexagon and nⱼ^{b} is the number of sub-channels allocated to a user j who is in the outer ring, tᵢ^{b} is an actual rate the user i can get and tⱼ^{b} is an actual rate the user j can get.

13. The method of claim 1, comprising simultaneously adjusting radius r and frequency reuse factors for the inner portion and the outer portion.

14. A system for controlling a cellular communication system, comprising:
a radio network controller in communication with each of the plurality of base stations, the radio network controller (1) solving a first equation for throughput for the cellular communication system for each of the plurality of possible inner radii r, the first equation being a function of the number of subcarriers, the frequency reuse and the size of the plurality of cells and (2) selecting one of the plurality of possible inner radii r that maximizes the first equation for throughput;
a plurality of base stations, each of the plurality of base stations associated with a cell that has a plurality of users, each of the plurality of base stations solving a second equation for throughput of each of the plurality of users, the second equation being a function of the one of the plurality of possible inner radii r.

15. The system of claim 14, wherein each of the plurality of base stations set communication parameters based on the second equation.

16. The system of claim 15, comprising setting a frequency reuse factor in an inner radius and an outer radius of a plurality of cells in the cellular communication system.

17. The system of claim 15, comprising setting a throughput for a plurality of cells in the cellular communication system.

18. The system of claim 15, wherein each of the plurality of base stations allocates subcarriers to a plurality of mobile communication units based on the throughput maximization solution.

19. The system of claim 14, wherein the cellular communication system is an orthogonal frequency division multiple access system.

20. The system of claim 14, wherein the first equation is
$${T}^{*} = {max}_{{N}_{1} , {N}_{p}} {\sum }_{b = 1}^{B} {t}_{r , j}^{*} {N}_{p} + {t}_{r , i}^{*} {N}_{1}$$
subject to:
N₁+pNₚ=M (5)
t_{r,j}^{*}Nₚ≧T₁_{_{j,r}}^{b}∀b (6)
t_{r,i}^{*}N₁≧T₁_{_{i,r}}^{b}∀b, (7)

21. The system of claim 14, wherein the second equation is:
$$\begin{matrix}{max}_{{n}_{i}^{b} , {n}_{j}^{b}} {\sum }_{i ∈ {I}_{i}} {t}_{i}^{b} {n}_{i}^{b} + {\sum }_{j ∈ {I}_{i}} {t}_{j}^{b} {n}_{j}^{b} & ( 8 ) \\ subject to {t}_{i}^{b} {n}_{i}^{b} \geq {t}^{min} , ∀ i & ( 9 ) \\ {t}_{j}^{b} {n}_{j}^{b} \geq {t}^{ min} , ∀ j & ( 10 ) \\ {\sum }_{i} {n}_{i}^{b} = {N}_{1} & ( 11 ) \\ {\sum }_{j} {n}_{j}^{b} = {N}_{ρ} & ( 12 )\end{matrix}$$
where nᵢ^{b} is the number of sub-channels allocated to a user i who is in the inner hexagon and nⱼ^{b} is the number of sub-channels allocated to a user j who is in the outer ring, tᵢ^{b} is an actual rate the user i can get and tⱼ^{b} is an actual rate the user j can get.

22. The system of claim 14, wherein the radius r and frequency reuse factors for the inner portion and the outer portion are adjusted simultaneously.

23. The system of claim 18, wherein the second equation is:
$$\begin{matrix}{max}_{{n}_{i}^{b} , {n}_{j}^{b}} {\sum }_{i ∈ {I}_{i}} {t}_{i}^{b} {n}_{i}^{b} + {\sum }_{j ∈ {I}_{i}} {t}_{j}^{b} {n}_{j}^{b} & ( 8 ) \\ subject to {t}_{i}^{b} {n}_{i}^{b} \geq {t}^{min} , ∀ i & ( 9 ) \\ {t}_{j}^{b} {n}_{j}^{b} \geq {t}^{ min} , ∀ j & ( 10 ) \\ {\sum }_{i} {n}_{i}^{b} = {N}_{1} & ( 11 ) \\ {\sum }_{j} {n}_{j}^{b} = {N}_{ρ} & ( 12 )\end{matrix}$$
where nᵢ^{b} is the number of sub-channels allocated to a user i who is in the inner hexagon and nⱼ^{b} is the number of sub-channels allocated to a user j who is in the outer ring, tᵢ^{b} is an actual rate the user i can get and tⱼ^{b} is an actual rate the user j can get.
